(19) United States
(12) Patent Application Publication
(10) Pub. No.: US 2008/0045640 A1
(43) Pub. Date: Feb. 21, 2008

(54) NANOCOMPOSITE MADE OF STAR-SHAPED STYROL-BUTADIENE BLOCK COPOLYMERS AND LAYER SILICATES

(75) Inventors: Volker Warzelhan, Weisenheim (DE); Thomas Breiner, Schifferstadt (DE); Konrad Knoll, Mannheim (DE); Chirag Tejuja, Singapur (SG)

Correspondence Address: CONNOLLY BOVE LODGE & HUTZ LLP, 1875 EYE STREET, N.W., SUITE 1100, WASHINGTON, DC, 20036, US

(73) Assignee: BASF AKTIENGESELLSCHAFT, Ludwigshafen (DE)

(21) Appl. No.: 11/577,565

(22) PCT Filed: Oct. 20, 2005
(86) PCT No.: PCT/EP05/11279

§ 371 Date: Apr. 19, 2007

(30) Foreign Application Priority Data
Oct. 25, 2004 (DE) 102004051924.2

(51) Int. Cl. C08K 9/04

(52) U.S. Cl. 524/445; 524/505

(57) ABSTRACT

The invention relates to a nanocomposite containing (I) a star-shaped, branched block copolymer made of vinylaromatic monomers and dienes and (II) a layer silicate. The invention also relates to a method for the production thereof.

The invention relates to a nanocomposite, comprising
(I) a star-shaped branched block copolymer composed of vinylaromatic monomers and of dienes, and
(II) a phyllosilicate, and process for their preparation.

Composite materials (nanocomposites) composed of organic polymers and of phyllosilicates are known, and feature high stiffness.

WO 00/34393 describes a process for preparation of nanocomposite substances with improved barrier properties via preparation of a concentrate composed of a phyllosilicate and of an amino-functionalized oligomer or polymer, and compounding of the concentrate with thermoplastic polymers, such as polyesters, polyamides, polycaprolactones, polyethylene adipates, or polystyrene.

B. Hoffmann et. al in Macromol. Rapid Commun. 21, pages 57-61 (2000) describe the morphology and rheology of nanocomposite substances based on polystyrene. Complete delamination of the layers could be achieved via the shear forces in melt-compounding of polystyrene with phyllosilicates which are modified with amino-functionalized polystyrene.

Nanocomposites of thermoplastic elastomers based on linear styrene-butadiene block copolymers or on linear styrene-isoprene block copolymers are also known (Yung-Hoon H et al, Macromolecules 2002, 35, pages 4419-4428). However, the proportion of delamination of the layer structures is very small.

It was an object of the present invention to find nanocomposites based on styrene-butadiene block copolymers with improved mechanical properties, in particular having high stiffness together with high tensile strain at break.

Accordingly, the nanocomposite described at the outset has been found.

The nanocomposite preferably comprises
(I) from 50 to 99% by weight, preferably from 75 to 95% by weight, of the star-shaped branched block copolymer, and
(II) from 1 to 50% by weight, preferably from 5 to 25% by weight, of the phyllosilicate.

The nanocomposites may also comprise other compatible, thermoplastic polymers. Polymers preferred here are those composed of monomers which are the same as those in the block copolymer, particularly styrene polymers. They may particularly preferably comprise polystyrene.

Particularly preferred nanocomposites are composed of
(I) from 50 to 95% by weight of a star-shaped branched block copolymer
(II) from 2 to 20% by weight of a phyllosilicate modified with an organic onium-salt compound
(III) from 3 to 30% by weight of a styrene polymer, in particular standard polystyrene (GPPS).

Suitable phyllosilicates (II) are synthetic or natural phyllosilicates, such as montmorillonite, smectite, illite, sepiolite, palygorskite, muscovite, allevardite, amesite, hectorite, fluorohectorite, saponite, beidellite, talc, nontronite, stevenite, bentonite, mica, vermiculite, fluorovermiculite, halloysite or a mixture thereof. Montmorillonite is preferred.

In order to enlarge the layer separations, the phyllosilicates may be modified with an organic onium salt compound, in particular ammonium salt compounds or phosphonium salt compounds. The phyllosilicate is preferably modified with an amino-functionalized styrene polymer. By way of example, the method of modification may be that described in WO 00/34393.

Particularly suitable star-shaped branched block copolymers are rigid block copolymers which are composed of from 60 to 90% by weight of vinylaromatic monomers and of from 10 to 40% by weight of diene, their structure mainly comprising hard blocks S which comprise vinylaromatic monomers, in particular styrene, and soft blocks B or B/S which comprise dienes, such as butadiene and isoprene.

Preference is given to polymodal styrene-butadiene block copolymers having terminal styrene blocks, for example those described in DE-A 25 50 227 or EP-A 0 654 488.

Particular preference is given to block copolymers having at least two hard blocks S₁ and S₂ composed of vinylaromatic monomers and having, between these, at least one random soft block B/S composed of vinylaromatic monomers and of dienes, the proportion of the hard blocks being above 40% by weight, based on the entire block copolymer, and where the 1,2-vinyl content in the soft block B/S is below 20%, these being as described in WO 00/58380.

The inventive nanocomposites may be prepared via modification of a phyllosilicate with an organic onium salt compound and subsequent mixing with a star-shaped block copolymer composed of vinylaromatic monomers and of dienes. The mixing may take place from solutions or dispersions or via melt compounding.

When compared with the block copolymers used without phyllosilicate, the inventive nanocomposites have higher modulus of elasticity with almost identical tensile strain at break.

### EXAMPLES

Preparation of Phyllosilicate-Nanocomposite Masterbatches

MB 1:

6 g of phyllosilicate (Cloisite Na⁺, Southern Clay Products) were suspended in 350 ml of distilled water and then heated to 60° C. The aqueous solution was then diluted with 200 ml of THF. 27.9 g of a terminally amino-functionalized polystryene (Mₙ 4500 g/mol, polydispersity 1.1) were dissolved in 150 ml of THF, 7 g of distilled water and 1.2 g of 50%-concentration hydrochloric acid were then added, thus adjusting the pH to 4-5. The polymer solution was added within a period of 5 minutes to the phyllosilicate solution. In order to complete the reaction, the reaction solution was stirred at 60° C. for 1 h, and then cooled. The polystyrene-modified phyllosilicate was obtained via filtration and then dried in vacuo at 50° C. Mineral content was determined by ignition as 17%.

MB 2:

6 g of phyllosilicate (Cloisite Na⁺, Southern Clay Products) were suspended in 300 ml of distilled water and then heated to 60° C. The aqueous solution was then diluted with 200 ml of THF. 12.4 g of a terminally amino-functionalized polystryene (Mₙ 4500 g/mol, polydispersity 1.1) were dissolved in 100 ml of THF, 5 g of distilled water and 0.3 g of concentrated hydrochloric acid were then added, thus adjusting the pH to 4-5. 1.6 g of dihexadecyldimethylammonium bromide (Aldrich) were then dissolved in 5 ml of THF and 10 ml of distilled water. The polymer solution was added within a period of 5 minutes to the phyllosilicate solution, and the reaction mixture was stirred at 60° C. for 15 min. The solution of the dihexadecyidimethylammonium bromide was then added within a period of 3 min., and the reaction mixture was stirred at 60° C. for one further hour, and then cooled. The polystyrene/dihexadecyidimethylammonium-modified phyllosilicate was obtained via filtration and then dried in vacuo at 50° C. Mineral content was determined via ignition as 26%.

MB 3:

6 g of phyllosilicate (Cloisite Na⁺, Southern Clay Products) were suspended in 300 ml of distilled water and then heated to 60° C. The aqueous solution was then diluted with 200 ml of THF. 14 g of a terminally amino-functionalized polybutadiene-block-polystyrene (Mₙ 4000 g/mol for polybutadiene block, 500 g/mol for polystyrene block) were dissolved in 100 ml of THF, 5 g of distilled water and 0.45 g of 50%-concentration hydrochloric acid were then added, thus adjusting the pH to 4-5. 1.6 g of dihexadecyldimethylammonium bromide (Aldrich) were then dissolved in 20 ml of THF and 30 ml of distilled water. The polymer solution was added within a period of 5 minutes to the phyllosilicate solution, and the reaction mixture was stirred at 60° C. for 15 min. The solution of the dihexadecyldimethylammonium bromide was then added within a period of 3 min., and the reaction mixture was stirred at 60° C. for one further hour, and then cooled. The polystyrene/dihexadecyldimethylammonium-modified phyllosilicate was obtained via filtration and then dried in vacuo at 50° C. Mineral content was determined via ignition as 28.5%.

Preparation of Nanocomposites with Star-Shaped Block Copolymers

SB 1:

A star-shaped block copolymer SB 1 (25% by weight of butadiene, 75% by weight of styrene) was prepared via sequential anionic polymerization of styrene and butadiene and subsequent coupling with epoxidized linseed oil by analogy with Example 1 of DE-A 25 50 227.

SB 2:

A star-shaped block copolymer SB 1 (26% by weight of butadiene, 74% by weight of styrene) having random S/B copolymer blocks was prepared via sequential anionic polymerization of styrene and butadiene and subsequent coupling with epoxidized linseed oil in accordance with Example 15 of WO 00/58380.

Measurements:

Mechanical values, such as modulus of elasticity, tensile strength, and tensile strain at break, were determined to ISO 527.

### Example 1

19.2 g of the modified phyllosilicate prepared in MB 2 were suspended in THF to give a 10% strength dispersion. 60.3 g of SB 1 were dissolved in 182 ml of THF. The suspension and the solution were combined and mixed for 5 h on a vibrating table. The solvent was then removed, and finally the specimen was dried in vacuo at 50° C. The mineral content of the nanocomposite is 3%.

### Example 2

3.8 g of the functionalized phyllosilicate prepared in MB 2 were suspended in THF to give a 10% strength solution. 12.06 g of SB 2 were dissolved in 60 ml of THF. The solution and suspension were combined and mixed for 5 h on a vibrating table. The solvent was then removed, and finally the specimen was dried in vacuo at 50° C.

### Example 3

3.7 g of the functionalized phyllosilicate prepared in MB 2 were suspended in THF to give a 10% strength solution. 16.3 g of SB 2 were dissolved in 90 ml of THF. The solution and suspension were combined and mixed for 5 h on a vibrating table. The solvent was then removed, and finally the specimen was dried in vacuo at 50° C.

### Example 4

0.92 g of the commercial organic phyllosilicate (Nanofil 919®, Süd-Chemie) were suspended in THF to give a 10% strength solution. 19.08 g of SB 2 were dissolved in 100 ml of THF. The solution and suspension were combined and mixed for 5 h on a vibrating table. The solvent was then removed, and finally the specimen was dried in vacuo at 50° C.

### Example 5

3.7 g of the functionalized phyllosilicate prepared in MB 2 were suspended in THF to give a 10% strength solution. 11.3 g of SB 2 and 5 g of homopolystyrene (polystyrene 158K) were dissolved in 55 ml and, respectively, 25 ml of THF. The three solutions and the suspension were combined and mixed for 5 h on a vibrating table. The solvent was then removed, and finally the specimen was dried in vacuo at 50° C.

### Example 6

18.4 g of the functionalized phyllosilicate prepared in MB 3 were suspended in THF to give a 10% strength solution. 60.6 g of SB 1 were dissolved in 182 ml of THF. The solution and suspension were combined and mixed for 5 h on a vibrating table. The solvent was then removed, and finally the specimen was dried in vacuo at 50° C. Mineral content of the nanocomposite is 3%.

The specimens prepared in Examples 1-6 were then melted at 195° C. for 3 min. in a microcompounder (DSM 15), and processed at 205° C. to give tensile specimens (l=90, w=5, t=1.6). The mold temperature here was 70° C.

TABLE 1
Mechanical properties of nanocomposite substances from Examples 1-6

| | | | | Tensile | Tensile |
|---|---|---|---|---|---|
| | Proportion of | Modulus of | Tensile | stress | strain |
| | block | elasticity | strength | at break | at break |
| Example | copolymer | [MPa] | [MPa] | [MPa] | [%] |
| Ex. 1 | 88.7 | 1818 | 29 | 32 | 127 |
| Ex. 2 | 88.7 | 1511 | 22 | 30 | 131 |
| Ex. 3 | 81.7 | 1652 | 23 | 30 | 154 |
| Ex. 4 | 95.4 | 1030 | 16 | 25 | 156 |
| Ex. 5 | 56.7 | 2505 | 39 | 37 | 82 |
| Ex. 6 | 89.2 | 616 | 11 | 20 | 183 |

1. A nanocomposite, comprising
(I) a star-shaped branched block copolymer composed of from 60 to 90% by weight of vinylaromatic monomers and of from 10 to 40% by weight of dienes, and
(II) a phyllosilicate.

2. The nanocomposite according to claim 1, which comprises
(I) from 50 to 99% by weight of the star-shaped branched block copolymer, and
(II) from 1 to 50% by weight of the phyllosilicate.

3. The nanocomposite according to claim 1, wherein the phyllosilicate is selected from the group consisting of montmorillonite, smectite, illite, sepiolite, palygorskite, muscovite, allevardite, amesite, hectorite, fluorohectorite, saponite, beidellite, talc, nontronite, stevenite, bentonite, mica, vermiculite, fluorovermiculite, halloysite and a mixture thereof.

4. The nanocomposite according to claim 1, wherein the phyllosilicate has been modified with an organic onium salt compound.

5. The nanocomposite according to claim 4, wherein the phyllosilicate has been modified with an amino-functionalized styrene polymer.

6. The nanocomposite according to claim 1, wherein the star-shaped branched block copolymer is a polymodal styrene-butadiene block copolymer having terminal styrene blocks.

7. The nanocomposite according to claim 1, wherein the star-shaped branched block copolymer comprises at least two hard blocks S₁ and S₂ composed of vinylaromatic monomers and comprises, between these, at least one random soft block B/S composed of from 60 to 90% by weight of vinylaromatic monomers and of from 10 to 40% by weight of dienes, the proportion of the hard blocks being above 40% by weight, based on the entire block copolymer.

8. The nanocomposite according to claim 7, wherein the at least one random soft block B/S is contains a 1,2-vinyl content below 20%.

9. A process for preparation of a nanocomposite comprising modifying a phyllosilicate with an organic onium salt compound and subsequently mixing with a star-shaped block copolymer composed of from 60 to 90% by weight of vinylaromatic monomers and of from 10 to 40% by weight of dienes.

10. The nanocomposite according to claim 2, wherein the phyllosilicate is selected from the group consisting of montmorillonite, smectite, illite, sepiolite, palygorskite, muscovite, allevardite, amesite, hectorite, fluorohectorite, saponite, beidellite, talc, nontronite, stevenite, bentonite, mica, vermiculite, fluorovermiculite, halloysite and a mixture thereof.

11. The nanocomposite according to claim 2, wherein the phyllosilicate has been modified with an organic onium salt compound.

12. The nanocomposite according to claim 3, wherein the phyllosilicate has been modified with an organic onium salt compound.

13. The nanocomposite according to claim 2, wherein the star-shaped branched block copolymer is a polymodal styrene-butadiene block copolymer having terminal styrene blocks.

14. The nanocomposite according to claim 3, wherein the star-shaped branched block copolymer is a polymodal styrene-butadiene block copolymer having terminal styrene blocks.

15. The nanocomposite according to claim 4, wherein the star-shaped branched block copolymer is a polymodal styrene-butadiene block copolymer having terminal styrene blocks.

16. The nanocomposite according to claim 5, wherein the star-shaped branched block copolymer is a polymodal styrene-butadiene block copolymer having terminal styrene blocks.

17. The nanocomposite according to claim 2, wherein the star-shaped branched block copolymer comprises at least two hard blocks S₁ and S₂ composed of vinylaromatic monomers and comprises, between these, at least one random soft block B/S composed of from 60 to 90% by weight of vinylaromatic monomers and of from 10 to 40% by weight of dienes, the proportion of the hard blocks being above 40% by weight, based on the entire block copolymer.

18. The nanocomposite according to claim 3, wherein the star-shaped branched block copolymer comprises at least two hard blocks S₁ and S₂ composed of vinylaromatic monomers and comprises, between these, at least one random soft block B/S composed of from 60 to 90% by weight of vinylaromatic monomers and of from 10 to 40% by weight of dienes, the proportion of the hard blocks being above 40% by weight, based on the entire block copolymer.

19. The nanocomposite according to claim 4, wherein the star-shaped branched block copolymer comprises at least two hard blocks S₁ and S₂ composed of vinylaromatic monomers and comprises, between these, at least one random soft block B/S composed of from 60 to 90% by weight of vinylaromatic monomers and of from 10 to 40% by weight of dienes, the proportion of the hard blocks being above 40% by weight, based on the entire block copolymer.

20. The nanocomposite according to claim 5, wherein the star-shaped branched block copolymer comprises at least two hard blocks S₁ and S₂ composed of vinylaromatic monomers and comprises, between these, at least one random soft block B/S composed of from 60 to 90% by weight of vinylaromatic monomers and of from 10 to 40% by weight of dienes, the proportion of the hard blocks being above 40% by weight, based on the entire block copolymer.
